(19) United States
(12) Patent Application Publication
(10) Pub. No.: US 2010/0018107 A1
(43) Pub. Date: Jan. 28, 2010

(54) Method and means for controlling the population of mosquitoes in a non-toxic manner

(76) Inventor: Kurt L. Christensen, Springfield, NE (US)

Correspondence Address: THOMTE LAW OFFICE, L.L.C., 2120 S. 72ND STREET, SUITE 1111, OMAHA, NE, 68124, US

(21) Appl. No.: 12/220,151

(22) Filed: Jul. 22, 2008

(51) Int. Cl. A01M 1/00

(52) U.S. Cl. 43/132.1

(57) ABSTRACT

A mosquito control capsule is provided which may be dropped in a body of water such as a livestock water tank, automatic livestock waterer, rain barrels, standing water or puddles. The capsule is comprised of a water-soluble material containing either soybean oil or corn oil with the capsule dissolving upon being placed in the body of water so that a thin film of oil covers the upper surface of the body of water to control the mosquito population. The capsule itself and the oil contained therein are non-toxic and are harmless to animals.

### BACKGROUND OF THE INVENTION

1. Field of the Invention

This invention relates to a method and means for controlling the population of mosquitoes in a non-toxic manner and more particularly to a method and means for controlling the population of mosquitoes in a body of water, such as in a livestock water tank, automatic livestock waterer, rain barrels, standing water or puddles.

2. Description of the Related Art

Many methods have been previously provided for controlling the population of mosquitoes such as in standing bodies of water, puddles, etc. The most common method of controlling the population of mosquitoes in water is to apply or spray a film of oil onto the body of water. Heretofore, the oil normally used would be diesel oil or fuel, etc. which is toxic to animals and livestock. Further, the conventional methods of applying oil to bodies of water also use toxic chemicals mixed with the oil.

Livestock water tanks and automatic livestock waterers are a haven for mosquitoes but it is not possible to apply diesel oil or fuel mixed with chemicals onto the water in the livestock water tanks or automatic livestock waterers since the same will most certainly be harmful to livestock such as horses, cattle, sheep, swine, poultry, pets and exotic livestock.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A method of means for controlling the population of mosquitoes in a body of water in a non-toxic manner is disclosed. The means for controlling the population of mosquitoes comprises a water soluble capsule comprised of a non-toxic material and soybean oil or corn oil contained within the water soluble capsule. The capsule is preferably comprised of gelatin, glycerin and water; and the soybean oil or corn oil is of the edible type.

The method of controlling the population of mosquitoes in a non-toxic manner comprises the steps of: (a) providing a water soluble capsule having soybean oil or corn oil therein; (b) placing the capsule into a body of water so that the capsule will dissolve thereby releasing the soybean oil therefrom to form a film of soybean oil or corn oil on the surface of the body of water.

The film of soybean oil or corn oil on the surface of the body of water controls the population of the mosquitoes and will not harm the livestock drinking from a livestock water tank, automatic livestock waterer, etc. The capsule may be used on any body of water such as rain barrels, standing water or puddles that form after heavy rain, etc. Preferably, the soybean oil or corn oil comprises 69% of the capsule with the capsule itself preferably being comprised of a gelatin, glycerin and purified water mixture in the amount of 19%, 9% and 3% respectively.

It is therefore a principal object of the invention to provide a method of controlling the population of mosquitoes in a non-toxic manner.

A further object of the invention is to provide a means for controlling the population of mosquitoes in a non-toxic manner.

A further object of the invention is to provide a mosquito control capsule with the capsule itself being comprised of a water-soluble mixture of gelatin, glycerin and purified water and with the capsule containing edible soybean oil or corn oil.

Still another object of the invention is to provide a mosquito control capsule which may be used in livestock water tanks and automatic livestock waterers without danger to the livestock consuming the water therefrom.

It is a further object of the invention to provide a mosquito control capsule for livestock tanks or the like wherein a water-soluble capsule containing soybean oil or corn oil may be conveniently dropped or deposited into a livestock water tank or the like.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the mosquito control capsule of this invention;

FIG. 2 is a sectional view of the capsule of FIG. 1 illustrating the capsule being filled with soybean oil or corn oil;

FIG. 3 illustrates a capsule of this invention being dropped into a livestock water tank; and

FIG. 4 is a sectional view of the livestock water tank of FIG. 3.

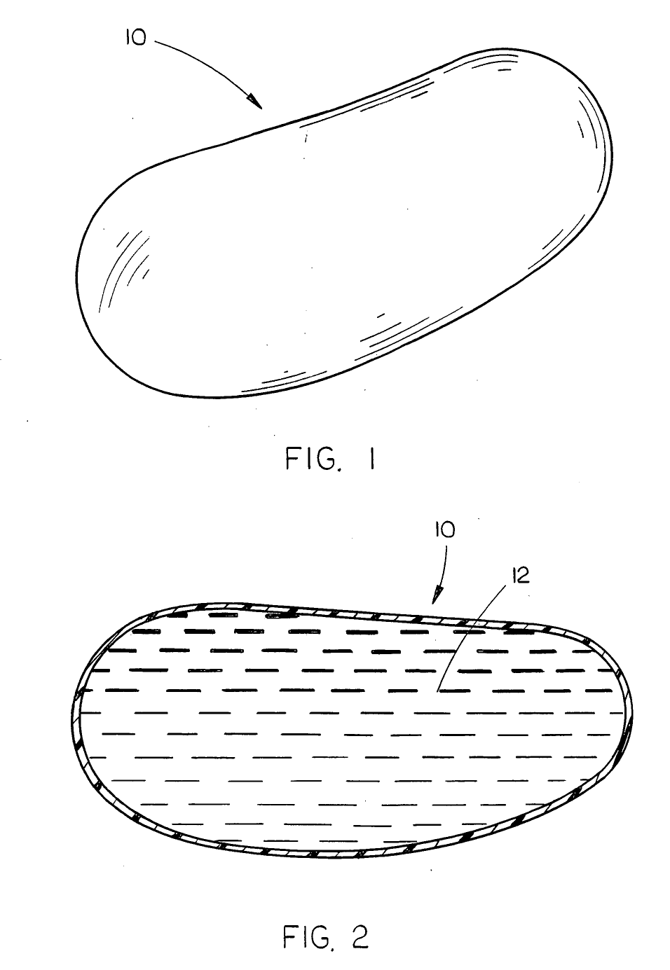

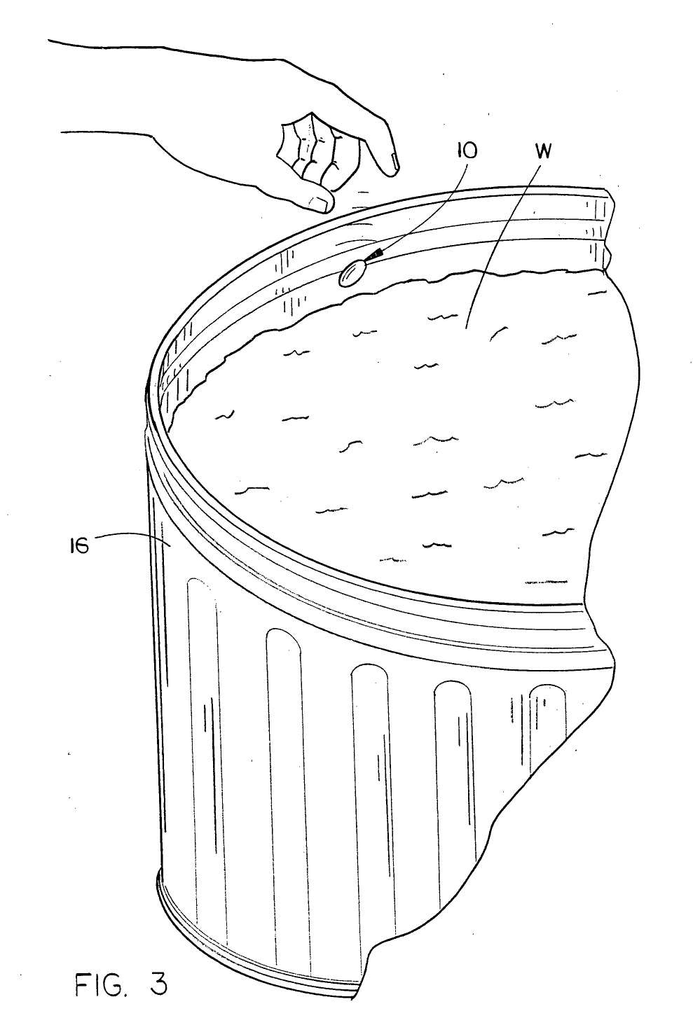

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The mosquito control capsule of this invention is referred to generally by the reference numeral 10 and may be of any shape but is preferably comprised of a clear, oblong-shaped, soft-gel capsule. The capsule is preferably comprised of gelatin, glycerin, and purified water so that the capsule will be water-soluble. It should be noted that other inert water-soluble materials can be used to form the capsule. The numeral 12 refers to edible soybean oil contained within the capsule 10. The active ingredient of the capsule 10 is soybean oil or corn oil in the amount of 69%, and the inert ingredients of gelatin, glycerin and purified water in the amounts of 19%, 9% and 3%. In one example of the capsule, the capsule itself is comprised of 280 milligrams gelatin, 124 milligrams glycerin and 46 milligrams of purified water and 1000 milligrams of soybean oil or corn oil contained therein.

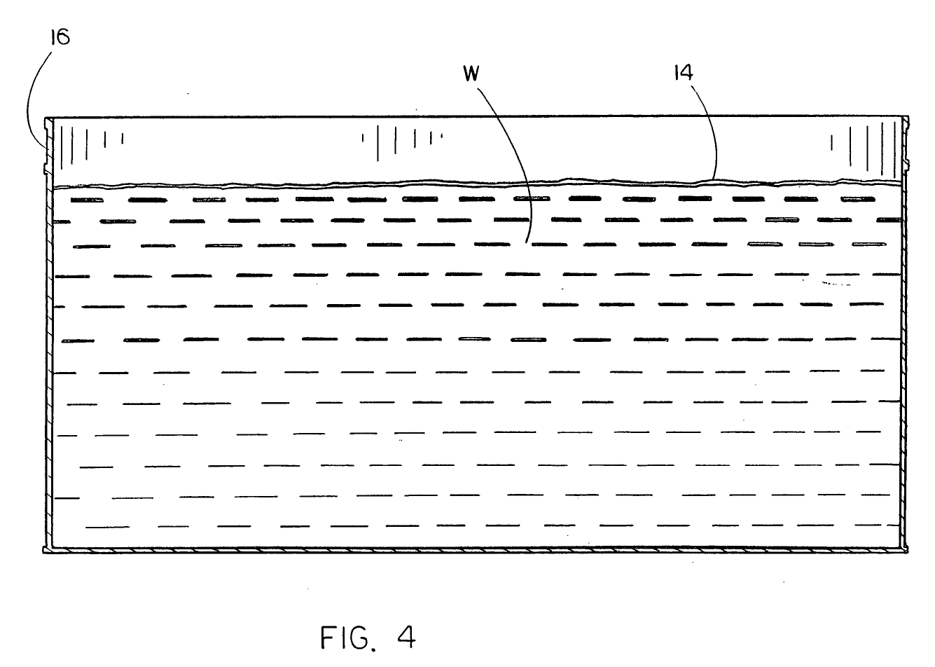

When placed into a body of water, the capsule 10 will dissolve, thereby releasing the soybean oil or corn oil 12 therefrom so that a thin film of oil 14 will be formed on the body of water. FIGS. 3 and 4 illustrate the body of water “W” being contained within a livestock tank 16. The body of water may be contained in an automatic livestock waterer, rain barrel, or may be a body of standing water or puddle left after a rain.

When used in a livestock tank 16, the thin film of oil 14 will spread over the entire upper surface of the water, thereby controlling the population of mosquitoes therein. The livestock will consume the water in the tank 16 and will not be harmed by the edible soybean oil or corn oil since there are no toxic chemicals associated therewith.

Assuming that the capsule 10 is to be used with a livestock tank 16, it is preferred that the tank be filled each day with one capsule 10 then being dropped into the tank. It is recommended that the tank 16 be topped off each day with a single capsule then being dropped into the tank. It may be that in some situations where the tank 16 is quite large, more than one capsule will have to be dropped into the tank each day.

Thus it can be seen that a novel method and means has been described for controlling the population of mosquitoes and which is particularly useful in livestock water tanks and automatic waterers to help control the population of mosquitoes. The capsule 10 is safe to be used for all species of livestock, including horses, cattle, sheep, swine, poultry and pets.

It can therefore be seen that the invention accomplishes all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. The method of controlling the population of mosquitoes in a non-toxic manner, comprising the steps of:
providing a water soluble capsule having either soybean oil or corn oil therein;
placing the capsule into a body of water so that the capsule will dissolve thereby releasing the oil therefrom to form a film of oil on the surface of the body of water;

2. The method of claim 1 wherein the capsule is comprised of a gelatin material.

3. The method of claim 2 wherein the capsule is also comprised of a glycerin material.

4. The method of claim 3 wherein the capsule is also comprised of purified water.

5. The method of claim 1 wherein the body of water is a livestock tank.

6. The method of claim 1 wherein the body of water is an animal waterer.

7. The method of claim 1 wherein the body of water is standing water.

8. The method of claim 1 wherein the body of water is a water container.

9. A non-toxic water soluble capsule containing either soybean oil or corn oil therein for placement into a body of water which will dissolve the capsule thereby releasing the soybean oil or corn oil therefrom to form a film of oil on the surface of the body of water.

10. The capsule of claim 9 wherein the capsule is comprised of a gelatin material.

11. The capsule of claim 10 wherein the capsule is also comprised of a glycerin material.

12. The capsule of claim 11 wherein the capsule is also comprised of water.

13. A means for controlling the population of mosquitoes in a body of water comprising:
a water-soluble capsule comprised of a non-toxic material; and
either corn oil or soybean oil contained within said water soluble capsule.

14. The means of claim 13 wherein said capsule is comprised of gelatin, glycerin and water.

15. The means of claim 13 wherein said soybean oil or corn oil is edible.
